(19) United States
(12) Patent Application Publication
(10) Pub. No.: US 2007/0019576 A1
(43) Pub. Date: Jan. 25, 2007

(54) Network computer having power frequency carrier

(75) Inventor: Yuan-Yu Huang, Taipei City (TW)

Correspondence Address: TROXELL LAW OFFICE PLLC, SUITE 1404, 5205 LEESBURG PIKE, FALLS CHURCH, VA, 22041, US

(73) Assignee: HANSDER ENGINEERING CO., LTD., Taipei City (TW)

(21) Appl. No.: 11/478,637

(22) Filed: Jul. 3, 2006

(30) Foreign Application Priority Data
Jul. 8, 2005 (TW) 094211659

(51) Int. Cl. H04B 7/00

(52) U.S. Cl. 370/310

(57) ABSTRACT

The present invention transfers signals over a power line, where power signals run over the power line are modulated into network signals in a power supplier of a computer to be inputted into the computer; and, conversely, network signals from the computer are modulated into power signals in the power supplier to be transmitted over the power line.

### FIELD OF THE INVENTION

The present invention relates to a network computer; more particularly, relates to receiving a power signal from an indoor power line, modulating the power signal into a network signal by a communication device with a power carrier module in a power supplier of the network computer, and outputting the network signal through a network interface in the power supplier into the network computer; and relates to, conversely, modulating a network signal from the network computer to obtain a power signal to be transmitted over the indoor power line.

### DESCRIPTION OF THE RELATED ARTS

A prior art, as shown in FIG. 6, called “an Ethernet communication device with a bridge and connection parts” is proclaimed in Taiwan, comprising a transmission interface 81 for a signal terminal 87 and a power terminal 86; and a power plug 82 to transmit signals over a power line. Therein, the signal terminal 87 is electronically connected to a RJ45 port of a computer and the power terminal 86 is electronically connected to a USB port of the computer. A bridge 8 of the Ethernet communication device obtains a DC (Direct Current) power from the USB port through the transmission interface 81; and the bridge 8 transforms Ethernet signals into HomePlug signals to be transmitted over the power line through the bridge 8, where the power required for transforming and transmitting the signals is provided by the DC power.

Although the above Ethernet communication device can link to the Internet, it still requires a network cable and a modem for the computer additionally. So, the prior art does not fulfill users requests on actual use.

### SUMMARY OF THE INVENTION

Therefore, the main purpose of the present invention is to transfer signals between computers over an indoor power line.

To achieve the above purpose, the present invention is a network computer with a power supplier plugged in an indoor power line by a computer power line through a power outlet to access signals, where the power supplier comprises a power unit, a communication device with a power carrier module, and a network interface; power signals are received by the power unit from the indoor power line through the computer power line and are transmitted to the communication device to be modulated into network signals to be entered into the network computer; and, conversely, network signals from the network computer are modulated into power signals to be outputted through the computer power line and to be transmitted over the indoor power line. Accordingly, a novel network computer having power frequency carrier is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a view showing a status of use according to a preferred embodiment of the present invention;

FIG. 2A is a view showing a process of receiving a signal by a power supplier according to the preferred embodiment of the present invention;

FIG. 2B is a view showing a process of outputting a signal by a power supplier according to the preferred embodiment of the present invention;

FIG. 3 is a view showing a communication device with a power carrier module according to the preferred embodiment of the present invention;

FIG. 4 is a view showing a status of use in a building according to the preferred embodiment of the present invention;

FIG. 5 is a view showing a status of use in a community according to the preferred embodiment of the present invention; and

FIG. 6 is a view showing a system structure having a power carrier module according to a prior art.

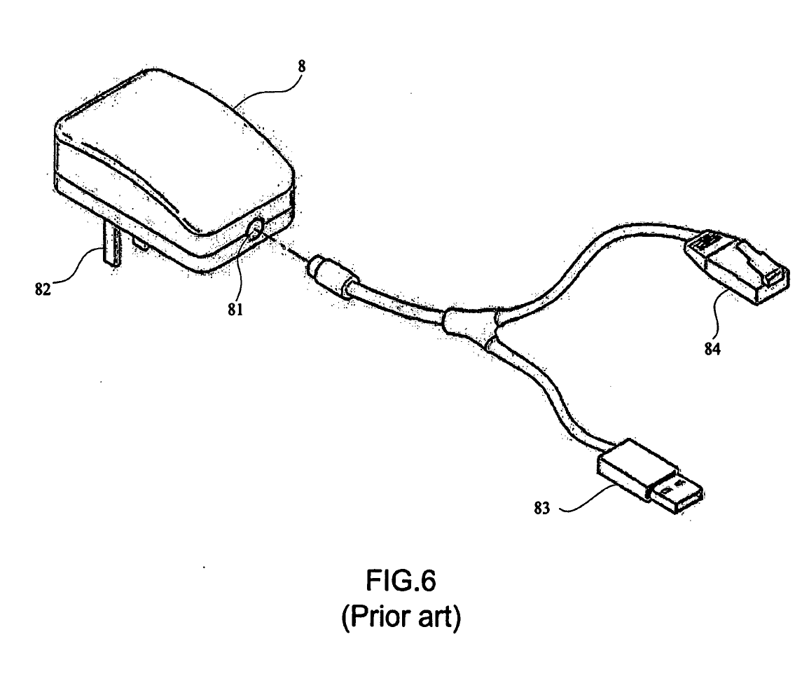

### DESCRIPTION OF THE PREFERRED EMBODIMENT

The following description of the preferred embodiment is provided to understand the features and the structures of the present invention.

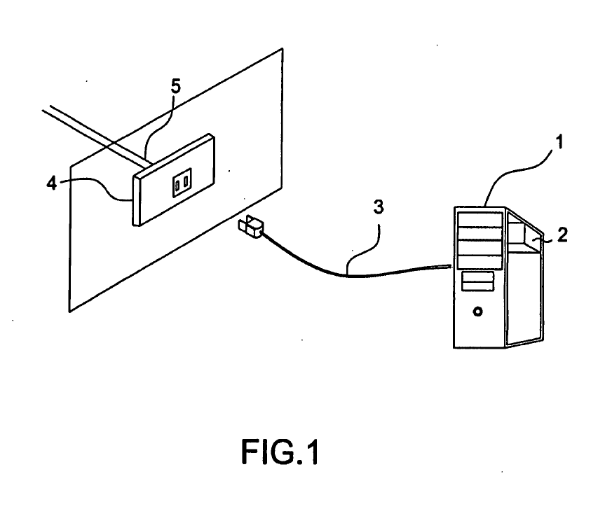

Please refer to FIG. 1, which is a view showing a status of use according to a preferred embodiment of the present invention. As shown in the figures, the present invention is a network computer having power frequency carrier, comprising a user-end network computer 1, a power supplier 2 and a computer power line 3. Therein, the user-end network computers 1 having the power supplier 2 can transmit signals over an indoor power line 5 by connecting the computer power lines 3 with the indoor power line 5 through the power outlets 4.

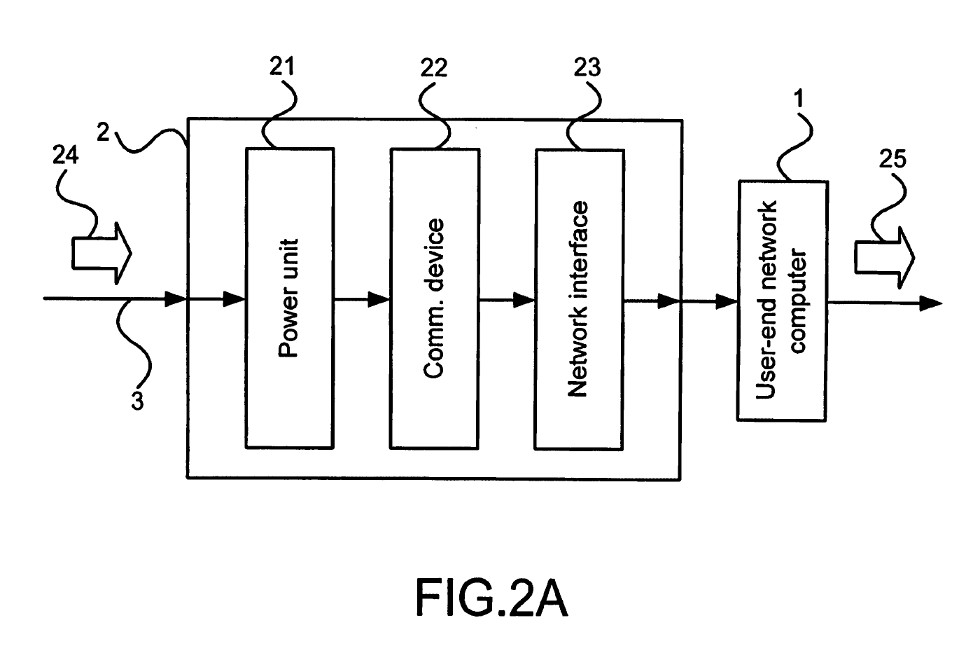

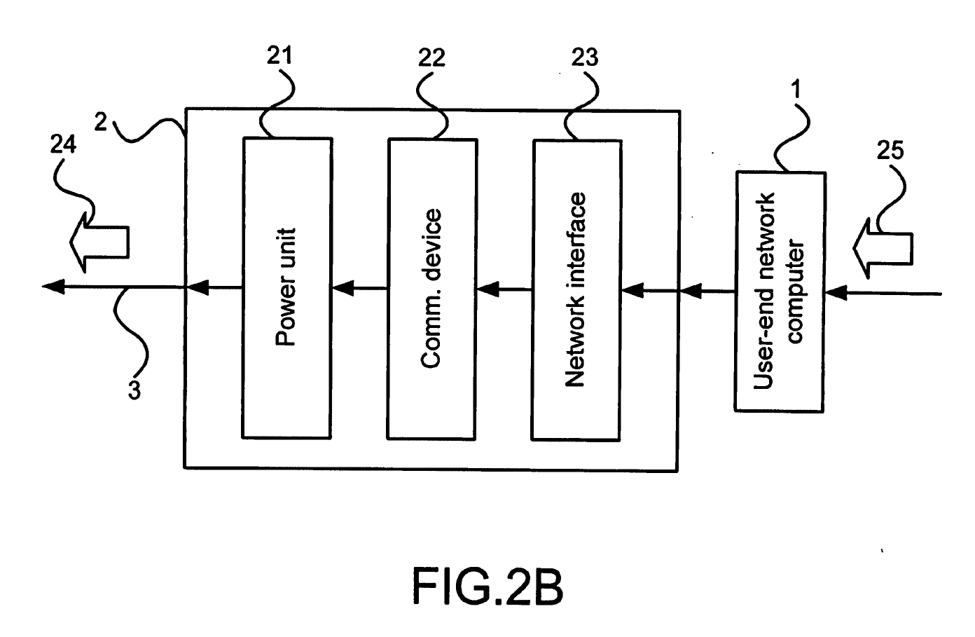

Please refer to FIG. 2A, which is a view showing a process of receiving a signal by a power supplier according to the preferred embodiment of the present invention. As shown in the figure, a power supplier 2 according to the present invention is comprised of a power unit 21, a communication device 22 with power frequency carrier, and a network interface 23. The method for receiving a signal in the power supplier 2 comprises steps of: (a) receiving a power signal 24 from the computer power line 3 by the power unit 21; (b) transmitting the power signal 24 into the communication device 22 to be modulated into a network signal 25; and (c) outputting the network signal 25 through the network interface 23 into a user-end network computer 1.

Please refer to FIG. 2B, which is a view showing a process of outputting a signal in the power supplier according to the preferred embodiment of the present invention. As shown in the figure, the method for outputting a signal in the power supplier 2 comprises steps of: (a) obtaining a network signal 25 from a user-end network computer 1 by the network interface 23; (b) transmitting the network signal 25 into the communication device 22 to be modulated into a power signal 24; and (c) outputting the power signal 24 to the computer power line 3 through the power unit 21.

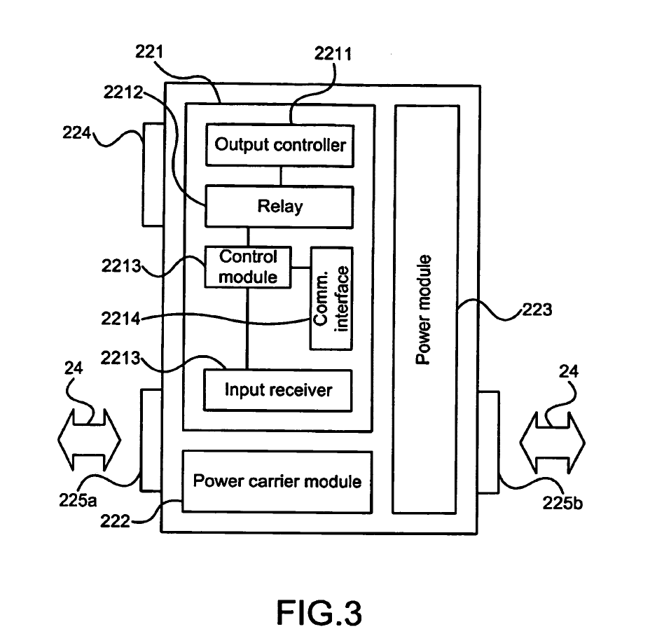

Please refer to FIG. 3, which is a view showing a communication device with a power carrier module according to the preferred embodiment of the present invention. As shown in the figure, a communication device 22 in a power supplier (not shown in the figure) according to the present invention comprises a single-chip control module 221, a power carrier module 222 with a transmission baud rate of 1200 BPS, a power module 223 supplying power to the single-chip control module 221 and the power carrier module 222, a signal indicator 224, an inside I/O device 225a and an outside I/O device 225b. Therein, the single-chip control module 221 comprises an output controller 2211, a relay 2212, a control module 2213, a communication interface 2214, and an input receiver 2215. The control module 2213 is a processor of a 8051 single-chip with a working frequency up to 16 MHz together with a 4 k size of electrically programmable and erasable ROM (Read Only Memory) together with eight input pins and eight output pins. The relay 2212 is located at the output pins to quarantine the circuit for securing and ensuring the operation of the 8051 single-chip. The 8051 single-chip contains a full-duplex communication interface 2214 inside. The communication interface 2214 can be an RS232 interface to transfer and receive data simultaneously from outside. Because the operational signals are on a TTL (transistor-transistor-logic) level (0 voltage set as logic 0; +5 voltage set as logic 1) and the communication interface 2214 is a serial communication interface to transfer or receive data in a form of series of bits, linkages can be easily established between two computers.

After a power signal 24 is received through the outside I/O device 225a to to be modulated into a network signal 25 by the power carrier module 222, a mode and a speed for a transmission are detected and setup by the single-chip control module 221; and an operational status is displayed by a signal indicator 224 of a light-emitting diode or an organic light-emitting diode. Then, a command from the single-chip control module 221 is then transmitted to the in side I/O device 225b, where the network signal 25 is transmitted to a network interface (not shown in the figure) through the inside I/O device 225b.

In the other hand, when a network signal 25 is transmitted to the inside I/O device 225b through the network interface, a mode and a speed for a transmission are detected and setup by the single-chip control module 221; and an operational status is displayed by a signal indicator 224 of a light-emitting diode or an organic light-emitting diode. A command is then sent to the outside I/O device 225a, where the network signal 25 is modulated into a power signal 24 by the power carrier module 222 to be outputted through the outside I/O device 225a.

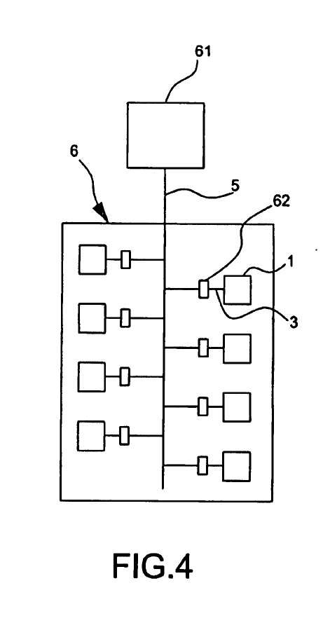

Please refer to FIG. 4, which is a view showing a status of use in a building according to the present invention. As shown in the figure, when the present invention is used in a building 6, every householder in the building 6 can link to the Internet. A power-line network server 61 can be set at a main I/O switcher of the indoor power line 5 of the building and a user-end wave filter 62 can be set at a user-end network computer 1 for a householder. The power-line network server 61 is used to access signals provided by an IS P (Internet Services Provider); and, by forming a power-line local network through the indoor power line 5 in the building 6, the householder can plug the householder's user-end network computer 1 in the indoor power line 5 with a computer power line 3 to access signals. The user-end wave filter 62 is used to block network signals, so that network signals from a user-end network computer 1 can be prevented from transferring to another user-end network computer 1 through the indoor power line 5 and, so, the transference efficiency of the power-line local network will not be lowered. In another way, if the householders want to transfer signals in between, the wave filters 62 at the user-end network computers 1 can be removed.

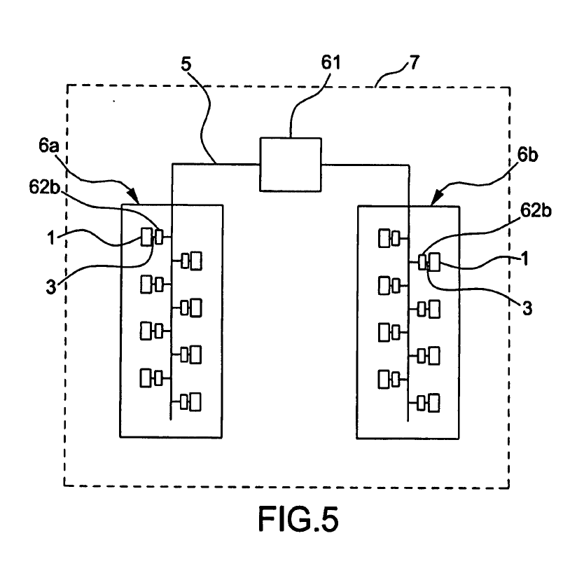

Please refer to FIG. 5, which is a view of a status of use in a community according to the present invention. As shown in the figure, when the present invention is applied in a community 7 of buildings 6a, 6b, every householder in the buildings 6a, 6b can link to the Internet. A power-line network server 61 can be set at a main I/O switcher of the indoor power line 5 in a center control room of the community 7; a building-end wave filter 63a, 63b can be set at a building 6a, 6b; and, a user-end wave filter 62a, 62b can be set at a user-end network computer 1 of a householder. The power-line network server 61 is used to access signals provided by an ISP for the community 7; and, by forming a power-line local network through the indoor power line 5 in the community 7, the householder can plug the householder's user-end network computer 1 in the indoor power line 5 with a computer power line 3 to access signals.

The user-end wave filter 62a, 62b is used to block network signals, so that network signals from a householder's user-end network computer 1 can be prevented from transmitting to another householder's user-end network computer 1 through the indoor power line 5; and the transmission efficiency of a power-line local network is not lowered. In another way, if the householders want to transfer signals between the user-end network computers 1, the wave filters 62a, 62b can be removed. In the same way, by using the building-end wave filters 63a, 63b, network signals from a building 6a, 6b can be prevented from transmitting to another building 6a, 6b through the indoor power line 5 and, so, the transmission efficiency of the power-line local network is not lowered. In another way, if the two buildings 6a, 6b want to transfer signals in between, the building-end wave filters 63a, 63b of the buildings 6a, 6b can be removed.

To sum up, the present invention is a network computer having power frequency carrier, where a power signal is transferred to a power supplier through an indoor power line; the power signal is modulated in the power supplier by a communication device with a power carrier module to obtain a network signal; the network signal is transferred through a network interface in the power supplier into a user-end network computer; and, in a converse way, a network signal from the user-end network computer can be modulated in the power supplier into a power signal by a communication device to be transferred over the indoor power line.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A network computer having power frequency carrier, comprising:
(a) a user-end network computer;
(b) a power supplier comprised of a power unit, a communication device with a power carrier module, and a network interface, said power supplier located in said user-end network computer;
(c) a computer power line accessing signals over an indoor power line for said power supplier.

2. The network computer according to claim 1, wherein said indoor power line supplies a general indoor power source.

3. The network computer according to claim 1, wherein said power supplier obtains a method for receiving a signal into said user-end network computer, comprising:
(a) obtaining a power signal from said computer power line by said power unit;
(b) transmitting said power signal into said communication device to be modulated into a network signal; and
c) outputting said network signal into said user-end network computer through said network interface.

4. The network computer according to claim 1, wherein said power supplier has a method for outputting a signal from said user-end network computer, comprising:
(a) obtaining a network signal from said user-end network computer through said network interface;
(b) transmitting said network signal to said communication device to be modulated into a power signal; and
(c) outputting said power signal to said computer power line through said power unit.

5. The network computer according to claim 1, where in said communication device is comprised of a single-chip control module, a power carrier module, a power module, an outside I/O device, an inside I/O device, and a signal indicator.

6. The network computer according to claim 1, wherein said single-chip control module is comprised of an input receiver, an output controller, a control module, a communication interface and a relay.

7. The network computer according to claim 1, wherein said power carrier module has a transmission rate of 1200 bits per second.

8. The network computer according to claim 1, wherein said control module is an 8051 single-chip.

9. The network computer according to claim 1, wherein said power carrier module has a working frequency of 16 megahertz.

10. The network computer according to claim 1, wherein said communication interface is an RS232 interface.
